(19) United States
(12) Patent Application Publication
(10) Pub. No.: US 2015/0349665 A1
(43) Pub. Date: Dec. 3, 2015

(54) PIEZOELECTRIC ACTUATOR AND ROBOT

(71) Applicant: Seiko Epson Corporation, Tokyo (JP)

(72) Inventors: Koichi KAMIJO, Matsumoto (JP); Osamu MIYAZAWA, Shimosuwa (JP); Yutaka ARAKAWA, Hara (JP)

(21) Appl. No.: 14/723,988

(22) Filed: May 28, 2015

(30) Foreign Application Priority Data
May 29, 2014 (JP) 2014-110945

(51) Int. Cl. H02N 2/10; B25J 9/12; H02N 2/12

(52) U.S. Cl. CPC H02N 2/103; H02N 2/12; B25J 9/126

(57) ABSTRACT

A piezoelectric actuator according to an embodiment includes a piezoelectric element, a vibrating plate including a main body section provided with the piezoelectric element, a fixing section, and a coupling section that couples the main body section and the fixing section, and a first member to which the vibrating plate is fixed. The fixing section is fixed to the first member by sandwiching the fixing section with the first member and a second member. In the thickness direction of the vibrating plate, each of the thicknesses of the first member and the second member is larger than the thickness of the fixing section. When viewed from the thickness direction of the vibrating plate, the main body section has a pair of sides opposed to each other. The vibrating plate includes a plurality of the coupling sections on one of the pair of sides of the main body section.

### BACKGROUND

1. Technical Field

The present invention relates to a piezoelectric actuator.

2. Related Art

A piezoelectric actuator is a driving device including a vibrating body, which includes a piezoelectric element that converts a driving voltage such as a high-frequency alternating-current voltage into mechanical vibration, and a driven body (e.g., a rotor) driven by the vibration (e.g., JP-A-2013-146152 (Patent Literature 1)). The vibrating body of the piezoelectric actuator described in Patent Literature 1 includes a pair of arm sections (fixing sections) extended toward latitudinal direction both outer sides. The vibrating body is fixed to a holding member via screws inserted through through-holes provided in the arm sections.

However, a fixing structure of the vibrating body described in Patent Literature 1 is likely to adversely affect a driving characteristic of the piezoelectric actuator. That is, the vibration of the vibrating body is sometimes transmitted to the arm sections to cause unintended resonance in the arm sections. The resonance sometimes interferes with original vibration of the vibrating body to disturb the motion of the vibrating body in a contact position with the driven body. Consequently, the strength of the contact of the vibrating body with the driven body and a mode of the contact such as a contact range are likely to change. As a result, the vibrating body cannot transmit appropriate driving force to the driven body. Driving efficiency of driving of the driven body and driving characteristics of the piezoelectric actuator such as positioning accuracy of the driven body are deteriorated.

### SUMMARY

An advantage of some aspects of the invention is to provide a technique capable of fixing a vibrating body with driving characteristics of a piezoelectric actuator stabilized.

### Application Example 1

A piezoelectric actuator according to this application example includes: a piezoelectric element; a vibrating plate including a main body section provided with the piezoelectric element, a fixing section, and a coupling section that couples the main body section and the fixing section; and a first member to which the vibrating plate is fixed. The fixing section is fixed to the first member by sandwiching the fixing section with the first member and a second member.

With this configuration, the fixing section is fixed to the first member by sandwiching the fixing section of the vibrating plate with the first member and the second member. Therefore, it is possible to suppress vibration of the vibrating plate from being transmitted to the fixing section to cause unintended resonance in the fixing section. Consequently, it is possible to stabilize driving characteristics of the piezoelectric actuator.

### Application Example 2

In the piezoelectric actuator according to the application example, it is preferable that, in the thickness direction of the vibrating plate, each of the thicknesses of the first member and the second member is larger than the thickness of the fixing section.

With this configuration, it is possible to more surely sandwich the fixing section with the first member and the second member and further stabilize the vibration.

### Application Example 3

In the piezoelectric actuator according to the application example, it is preferable that, when viewed from the thickness direction of the vibrating plate, the main body section has a pair of sides opposed to each other, and the vibrating plate includes a plurality of the coupling sections on one of the pair of sides of the main body section.

With this configuration, when the vibrating plate vibrates, it is possible to suppress deviation and flopping of the vibrating plate.

### Application Example 4

In the piezoelectric actuator according to the application example, it is preferable that the fixing section is configured by one member and is coupled to the main body section by the plurality of coupling sections.

Since the fixing section is configured by one member, it is possible to suppress deformation and distortion of the fixing section and the coupling section when the fixing section is fixed to the first member and the second member.

When the fixing section is configured by one member and is coupled to the main body section by the plurality of coupling sections, spurious vibration is likely to occur. However, since the fixing section is sandwiched by the first member and the second member, it is possible to suppress the spurious vibration and stabilize vibration.

### Application Example 5

In the piezoelectric actuator according to the application example, it is preferable that, when viewed from the thickness direction of the vibrating plate, the main body section has a pair of sides opposed to each other, and the vibrating plate includes a plurality of the coupling sections on each of the pair of sides of the main body section.

With this configuration, when the vibrating plate vibrates, it is possible to suppress deviation and flopping of the vibrating plate.

### Application Example 6

In the piezoelectric actuator according to the application example, it is preferable that the piezoelectric actuator includes a pair of the fixing sections, each of the pair of fixing sections is configured by one member, one of the pair of fixing sections is coupled to the main body section by the plurality of coupling sections provided on one of the pair of sides of the main body section, and the other of the pair of fixing sections is coupled to the main body section by the plurality of coupling sections provided on the other of the pair of sides of the main body section.

Since the fixing section is configured by one member, it is possible to suppress deformation and distortion of the fixing section and the coupling section when the fixing section is fixed to the first member and the second member.

When the fixing section is configured by one member and is coupled to the main body section by the plurality of coupling sections, spurious vibration is likely to occur. However, since the fixing section is sandwiched by the first member and the second member, it is possible to suppress the spurious vibration and stabilize vibration.

### Application Example 7

In the piezoelectric actuator according to the application example, it is preferable that the piezoelectric actuator includes an insulating member at least between the first member and the fixing section or between the second member and the fixing section.

With this configuration, even when a voltage is applied to the vibrating plate to drive the piezoelectric actuator, it is possible to set the potential of at least one of the first member and the second member of the piezoelectric actuator to the earth potential.

### Application Example 8

In the piezoelectric actuator according to the application example, it is preferable that at least one of the first member and the second member has an insulation property.

With this configuration, even when a voltage is applied to the vibrating plate to drive the piezoelectric actuator, it is possible to set the potential of at least one of the first member and the second member of the piezoelectric actuator to the earth potential.

### Application Example 9

In the piezoelectric actuator according to the application example, it is preferable that a hole, through which a wire electrically connected to the piezoelectric element is inserted, is provided in at least one of the first member and the second member.

With this configuration, it is possible to attain a reduction in the size of the piezoelectric actuator.

### Application Example 10

In the piezoelectric actuator according to the application example, it is preferable that an opening is provided in a position opposed to the piezoelectric element of at least one of the first member and the second member.

With this configuration, it is possible to radiate generated heat, attain a reduction in weight, and check whether a wire electrically connected to the piezoelectric element is normal. For example, when the wire is connected by solder or the like, it is possible to prevent the solder from interfering with the first member and the second member.

### Application Example 11

In the piezoelectric actuator according to the application example, it is preferable that each of the first member and the second member is configured by one member.

With this configuration, when the vibrating plate includes a pair of fixing sections, in each of the first member and the second member, it is possible to easily improve dimension accuracy in the positions of the fixing sections and positions in the vicinities of the fixing sections. It is possible to increase the rigidity of the first member and the second member.

### Application Example 12

In the piezoelectric actuator according to the application example, it is preferable that the piezoelectric actuator includes a driven body provided to be displaceable, and the vibrating plate includes a contact section that comes into contact with the driven body.

With this configuration, it is possible to provide the piezoelectric actuator equipped with the driven body without separately providing the driven body. It is possible to easily perform assembly work for the piezoelectric actuator including the driven body.

### BRIEF DESCRIPTION OF THE DRAWINGS

The invention will be described with reference to the accompanying drawings, wherein like numbers reference like elements.

FIG. 1 is a perspective view showing a piezoelectric actuator according to a first embodiment of the invention.

FIG. 2 is an exploded perspective view of a vibrating section of the piezoelectric actuator shown in FIG. 1.

FIG. 3 is a perspective view of the vibrating section of the piezoelectric actuator shown in FIG. 1 viewed from another direction.

FIG. 4 is a perspective view of the vibrating section of the piezoelectric actuator shown in FIG. 1 viewed from another direction.

FIG. 5 is a sectional view (a sectional view taken along line A-A) of the vibrating section of the piezoelectric actuator shown in FIG. 1.

FIGS. 6A and 6B are diagrams of the vibrating body for explaining the operation of the piezoelectric actuator shown in FIG. 1.

FIGS. 7A and 7B are diagrams of the vibrating body for explaining the operation of the piezoelectric actuator shown in FIG. 1.

FIGS. 8A and 8B are diagrams of the vibrating body for explaining the operation of the piezoelectric actuator shown in FIG. 1.

FIG. 9 is a diagram of the vibrating body for explaining the operation of the piezoelectric actuator shown in FIG. 1.

FIG. 10 is a diagram of the vibrating body for explaining the operation of the piezoelectric actuator shown in FIG. 1.

FIG. 11 is a plan view showing a vibrating body of a piezoelectric actuator in a second embodiment of the invention.

FIG. 12 is a plan view showing a vibrating body of a piezoelectric actuator in a third embodiment of the invention.

### DESCRIPTION OF EXEMPLARY EMBODIMENTS

Exemplary embodiments of the invention are explained in detail below with reference to the accompanying drawings.

### First Embodiment

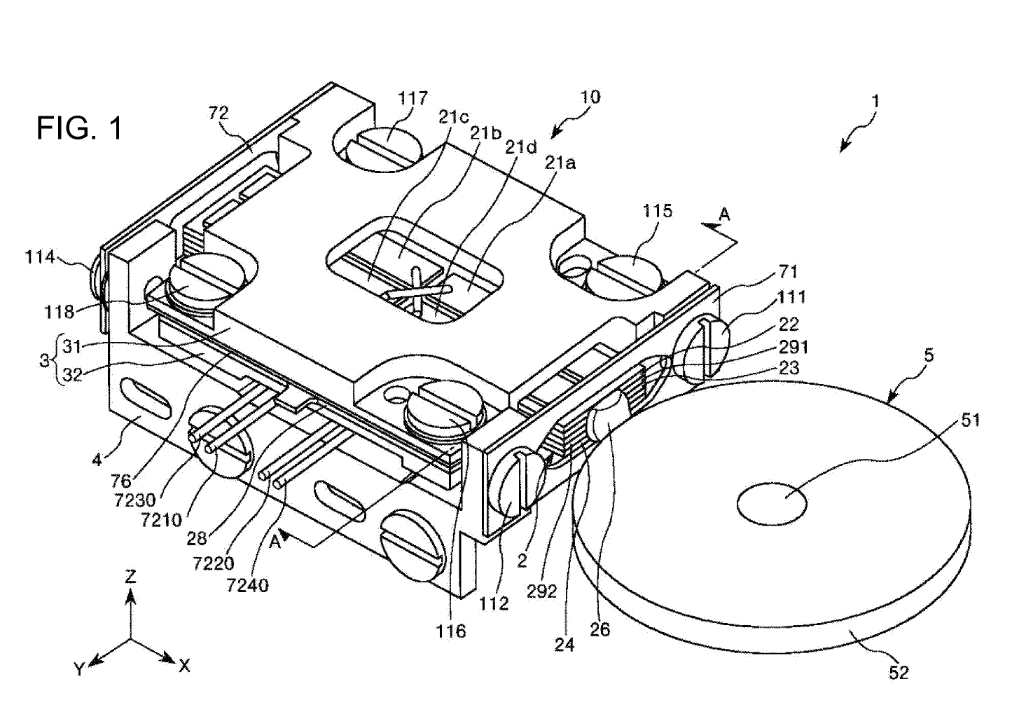

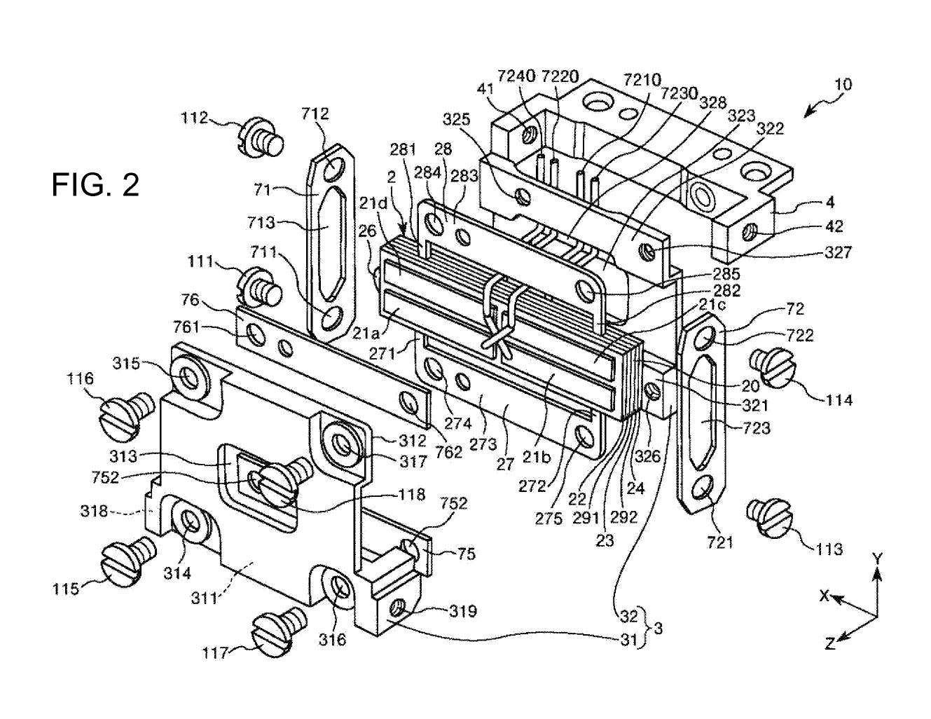

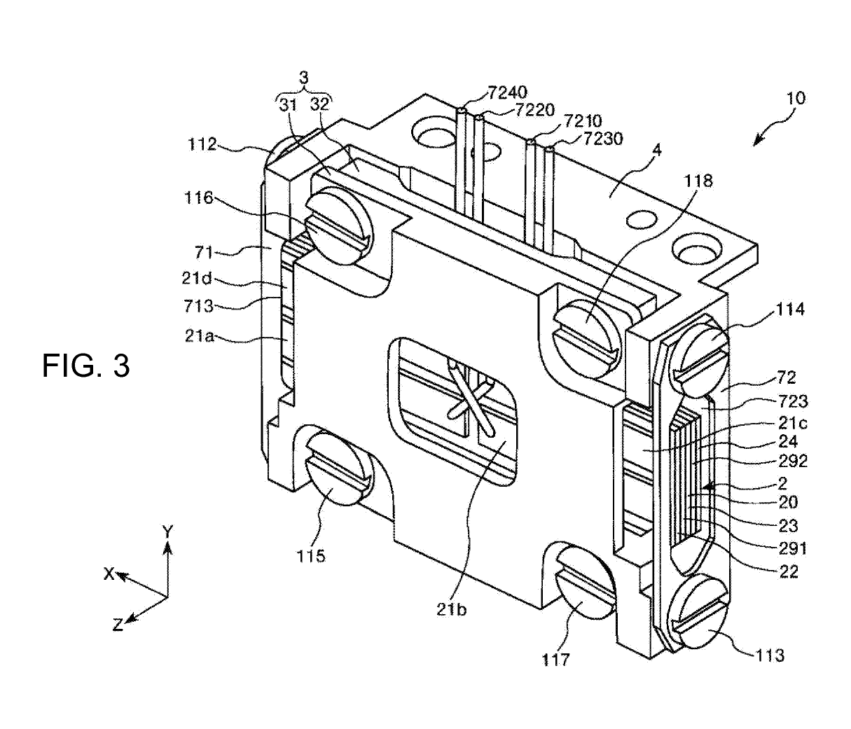

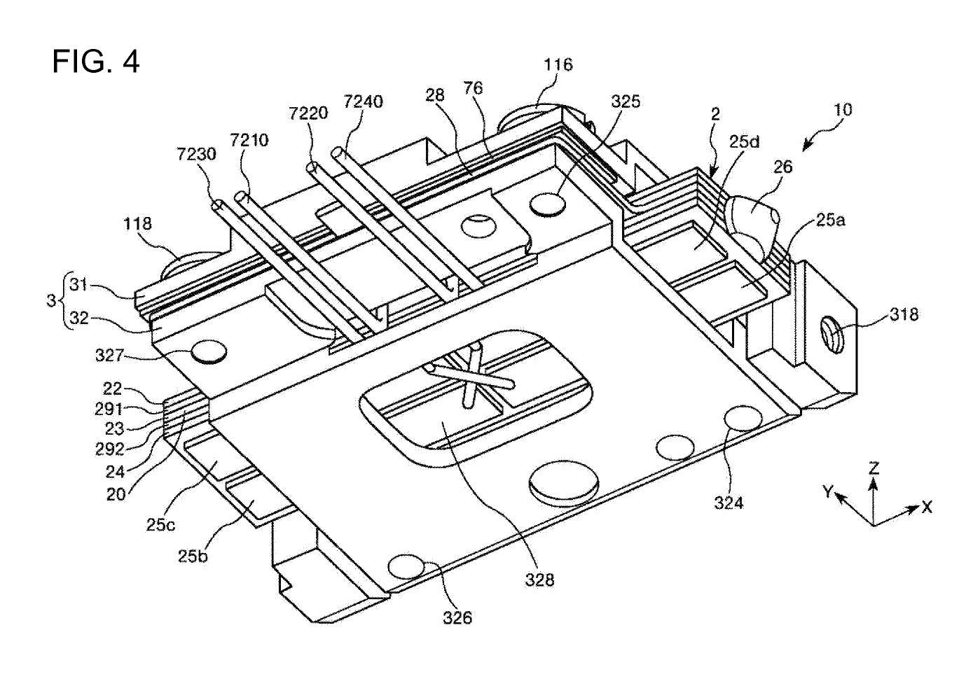

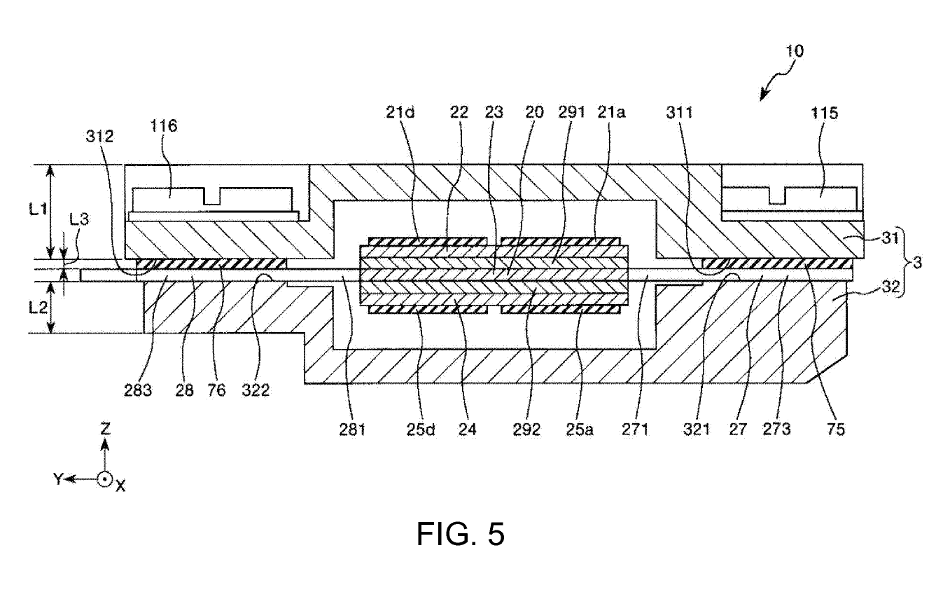

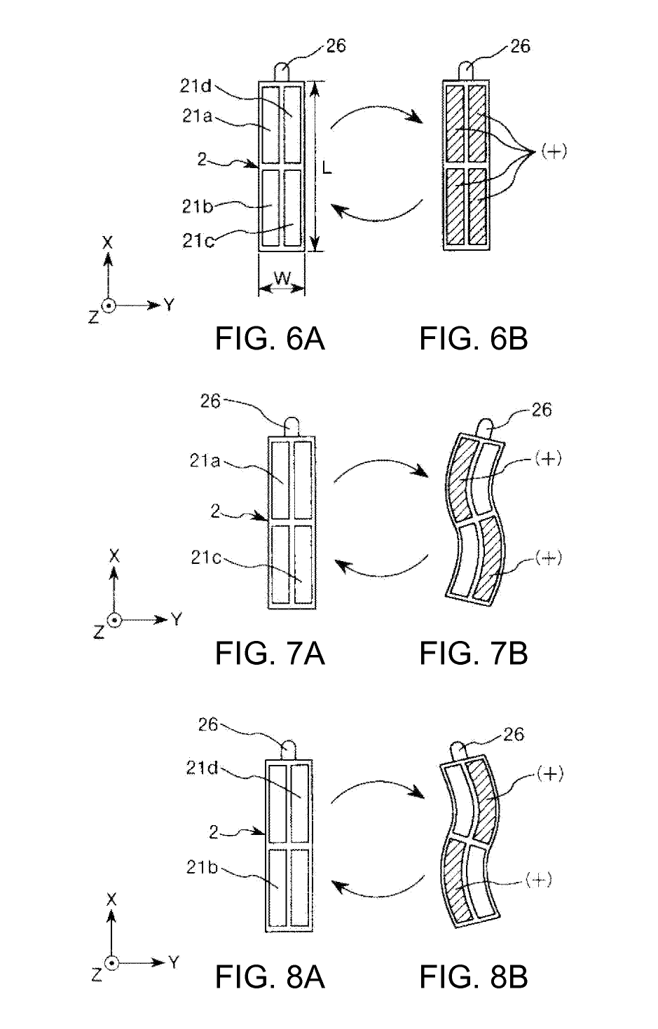

FIG. 1 is a perspective view of a piezoelectric actuator according to a first embodiment of the invention. FIG. 2 is an exploded perspective view of a vibrating section of the piezoelectric actuator shown in FIG. 1. FIG. 3 is a perspective view of the vibrating section of the piezoelectric actuator shown in FIG. 1 viewed from another direction. FIG. 4 is a perspective view of the vibrating section of the piezoelectric actuator shown in FIG. 1 viewed from another direction. FIG. 5 is a sectional view (a sectional view taken along line A-A) of the vibrating section of the piezoelectric actuator shown in FIG. 1. FIGS. 6A to 10 are respectively diagrams of the vibrating body for explaining the operation of the piezoelectric actuator shown in FIG. 1.

Note that, in the following explanation, for convenience of explanation, an upper side in FIGS. 1 and 5 is referred to as “up” or “upper” and a lower side in FIGS. 1 and 5 is referred to as “down” or “downward”.

In FIGS. 1 to 10, as three axes orthogonal to one another, an X axis, a Y axis, and a Z axis are shown. A direction parallel to the X axis is referred to as “X-axis direction”, a direction parallel to the Y axis is referred to as “Y-axis direction”, and a direction parallel to the Z axis is referred to as “Z-axis direction”. A plane defined by the X axis and the Y axis is referred to as “XY plane”, a plane defined by the Y axis and the Z axis is referred to as “YZ plane”, and a plane defined by the Z axis and the X axis is referred to as “XZ plane”. In the X-axis direction, the Y-axis direction, and the Z-axis direction, an arrow distal end side is referred to as “+ (plus) side” and an arrow proximal end side is referred to as “− (minus) side”.

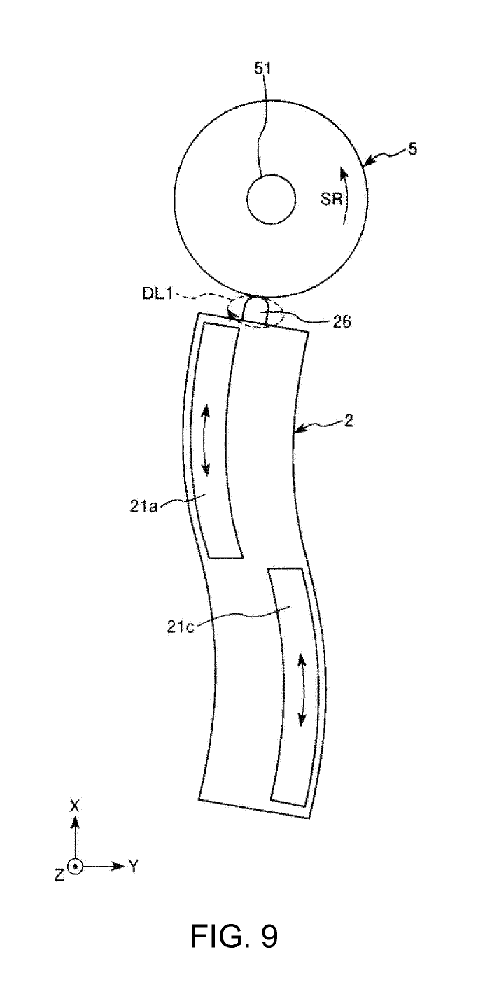

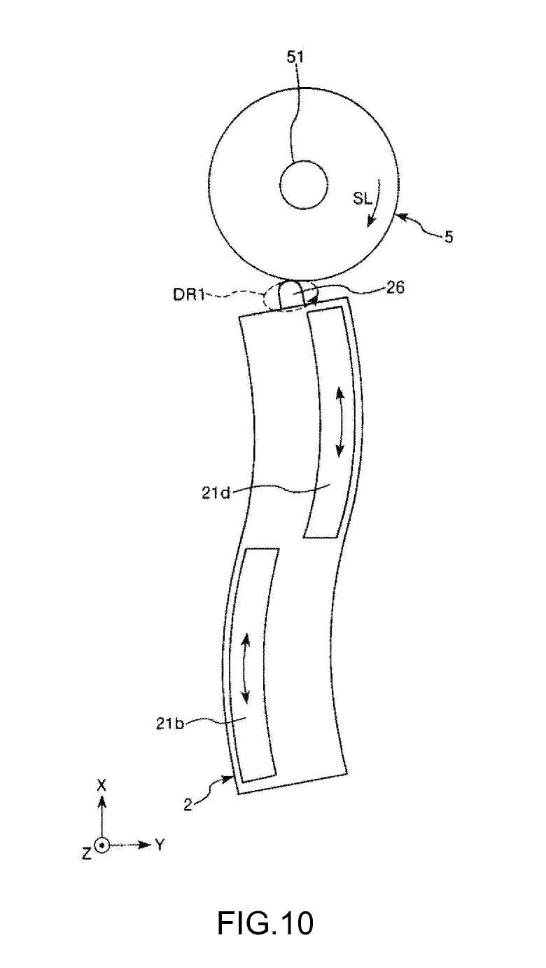

In FIG. 4, a base and leaf springs are not shown. In FIGS. 6A to 10, the vibrating body is simplified and shown by, for example, not showing coupling sections. In FIGS. 6A to 8B, electrodes to be energized among electrodes of the vibrating body are hatched. In FIGS. 9 and 10, only electrodes to be energized among the electrodes of the vibrating body are shown.

### Basic Configuration

As shown in FIG. 1, a piezoelectric actuator 1 includes a vibrating section 10 including a vibrating body 2 that vibrates with application of a voltage, a rotatable (displaceable) disk-like rotor (driven body) 5, and a not-shown supporting body that supports the vibrating section 10 and the rotor 5. Note that, in other words, the rotor 5 is a driven body, a cross sectional shape of which is a circular shape.

The piezoelectric actuator 1 is a device that transmits power (driving force) to the rotor 5 and rotates (drives) the rotor 5 according to the vibration of the vibrating body 2. The sections of the piezoelectric actuator 1 are sequentially explained below.

Vibrating section 10

As shown in FIGS. 1 to 5, the vibrating section 10 includes the vibrating body 2, a holding section (a holding mechanism) 3 that holds the vibrating body 2 (a vibrating plate 23) to be capable of vibrating, abase 4, a pair of leaf springs (elastic bodies) 71 and 72, which are urging sections that couple the holding section 3 and the base 4 and urges a projection 26 (explained below) of the vibrating body 2 toward the rotor 5 via the holding section 3, and a pair of insulating plates (insulating members) 75 and 76.

### Vibrating Body 2

The vibrating body 2 is formed in a rectangular tabular shape and configured by stacking, from the upper side in FIGS. 1 and 5, four electrodes 21a, 21b, 21c, and 21d, a tabular piezoelectric element 22, an electrode 291, the vibrating plate (a shim) 23, which is a reinforcing plate, an electrode 292, a tabular piezoelectric element 24, and four electrodes 25a, 25b, 25c, and 25d in this order (see FIGS. 1 to 5). The vibrating plate 23 includes a main body section 20, on one surface of which the piezoelectric element 22 is provided and on the other surface of which the piezoelectric element 24 is provided, a projection (a contact section) 26, and two coupling sections 27 and 28. Note that the vibrating body 2 in the figures are shown in exaggeration in the thickness direction.

The vibrating body 2 vibrates according to deformation of the piezoelectric elements 22 and 24 by application of a voltage, transmits power to the rotor 5 via the projection 26, and rotates the rotor 5.

The electrodes 291 and 292 are respectively formed in rectangular shapes corresponding to the piezoelectric elements 22 and 24 and respectively set (fixedly attached) on both surfaces of the main body section 20 of the vibrating plate 23.

The piezoelectric elements 22 and 24 are respectively formed in rectangular shapes and respectively set in the electrodes 291 and 292.

The piezoelectric elements 22 and 24 expand or contract in the longitudinal direction thereof according to application of a voltage. When the application of the voltage is stopped, the piezoelectric elements 22 and 24 return to the original shapes thereof.

The constituent materials of the piezoelectric elements 22 and 24 are respectively not particularly limited. Various materials such as lead zirconate titanate (PZT), quartz, lithium niobate, barium titanate, lead titanate, lead metaniobate, polyvinylidene fluoride, lead zinc niobate, and scandium lead niobate can be used.

The upper surface of the piezoelectric element 22 is substantially equally divided into four rectangular regions. The electrodes 21a, 21b, 21c, and 21d formed in a rectangular shape are respectively set in the divided regions. Similarly, the lower surface of the piezoelectric element 24 is substantially equally divided into four rectangular regions. The electrodes 25a, 25b, 25c, and 25d formed in a rectangular shape are respectively set in the divided regions.

Note that the electrode 21a and the electrode 25a, the electrode 21b and the electrode 25b, the electrode 21c and the electrode 25c, and the electrode 21d and the electrode 25d are respectively arranged to be opposed to each other in the thickness direction of the vibrating body 2 (the Z-axis direction).

Among the electrodes 21a, 21b, 21c, and 21d, the electrodes 21a and 21c on one diagonal line are electrically connected and the electrodes 21b and 21d on the other diagonal line are electrically connected. Similarly, among the electrodes 25a, 25b, 25c, and 25d, the electrodes 25a and 25c on one diagonal line are electrically connected and the electrodes 25b and 25d on the other diagonal line are electrically connected. A wire 7210 electrically connected to the electrodes 21a and 21c, a wire 7220 electrically connected to the electrodes 21b and 21d, a wire 7230 electrically connected to the electrodes 25a and 25c, and a wire 7240 electrically connected to the electrodes 25b and 25d are provided.

The vibrating plate 23 has a function of reinforcing the entire vibrating body 2 and prevents the vibrating body 2 from being damaged by overamplitude, external force, and the like. A constituent material of the vibrating plate 23 is not particularly limited. However, the constituent material of the vibrating plate 23 is preferably various metal materials such as stainless steel, aluminum or an aluminum alloy, titanium or a titanium alloy, copper or a copper alloy, or a 42 alloy.

The main body section 20 of the vibrating plate 23 is preferably thinner (smaller) than the piezoelectric elements 22 and 24. Consequently, it is possible to vibrate the vibrating body 2 at high efficiency.

The vibrating plate 23 is grounded (connected to the earth potential). Therefore, the electrodes 291 and 292 are grounded. Consequently, a voltage is applied to the piezoelectric element 22 by a predetermined electrode among the electrodes 21a, 21b, 21c, and 21d and the electrode 291. A voltage is applied to the piezoelectric element 24 by a predetermined electrode among the electrodes 25a, 25b, 25c, and 25d and the electrode 292.

Note that the electrodes 291 and 292 may be omitted. The vibrating plate 23 may be used as a common electrode for the piezoelectric elements 22 and 24. In this case, a voltage is applied to the piezoelectric element 22 by a predetermined electrode among the electrodes 21a, 21b, 21c, and 21d and the vibrating plate 23. A voltage is applied to the piezoelectric element 24 by a predetermined electrode among the electrodes 25a, 25b, 25c, and 25d and the vibrating plate 23.

The main body section 20 of the vibrating plate 23 is formed in a rectangular shape. The projection 26 is integrally formed at one end portion (an end portion on the rotor 5 side) in the longitudinal direction (the X-axis direction) of the main body section 20. In other words, the piezoelectric elements 22 and 24 are provided on a side opposite to the rotor 5 of the projection 26.

The projection 26 is located in the center portion in the width direction of the vibrating body 2. In this embodiment, the distal end side of the projection 26 is formed in a thin truncated cone shape or a truncated pyramid shape. Note that it goes without saying that the shape and the position of the projection 26 are not limited to the shape and the position.

The projection 26 comes into contact with the rotor 5 and separates from the rotor 5 according to the vibration of the vibrating body 2.

Coupling sections 27 and 28 that couple the vibrating plate 23 to the holding section 3 to enable the vibrating body 2 to vibrate are respectively integrally formed at both the end portions in the width direction (the Y-axis direction) of the main body section 20 of the vibrating plate 23, that is, a pair of sides opposed to each other in the Y-direction of the main body section 20. Each of the coupling sections 27 and 28 is configured by one member. The coupling sections 27 and 28 are disposed to be symmetrical to each other on the upper side and the lower side in FIG. 2 of the main body section 20. By configuring the coupling section 27 (a fixing section 273) from one member rather than a plurality of members, it is possible to suppress deformation and distortion of the fixing section 273 and coupling sections 271 and 272 when the fixing section 273 is fixed to the holding section 3 by screwing. Similarly, by configuring the coupling section 28 (a fixing section 283) from one member rather than a plurality of members, it is possible to suppress deformation and distortion of the fixing section 283 and coupling sections 281 and 282 when the fixing section 283 is fixed to the holding section 3 by screwing.

The coupling section 27 includes the fixing section 273 fixed (attached) to the holding section 3 (explained below) and formed in a rectangular shape and the coupling sections 271 and 272 formed at both the end portions in the longitudinal direction of the fixing section 273. The coupling sections 271 and 272 couple the main body section 20 and the fixing section 273 and support the vibrating body 2 to be capable of vibrating. Similarly, the coupling section 28 includes the fixing section 283 fixed (attached) to the holding section 3 and formed in a rectangular shape and the coupling sections 281 and 282 formed at both the end portions in the longitudinal direction of the fixing section 283. The coupling sections 281 and 282 couple the main body section 20 and the fixing section 283 and support the vibrating body 2 to be capable of vibrating. The coupling sections 271, 272, 281, and 282 are disposed in positions of nodes of bending vibration (explained below) of the vibrating body 2 (the vibrating plate 23).

As explained above, the two coupling sections 271 and 272 are provided in the positions of the nodes of the bending vibration on one end side of the vibrating plate 23 and the two coupling sections 281 and 282 are provided in the positions of the nodes of the bending vibration on the other end side. Consequently, it is possible to suppress deviation and flopping of the vibrating body 2 when the vibrating body 2 vibrates. When the vibrating body 2 vibrates, it is possible to suppress the coupling sections 271, 272, 281, and 282 from hindering the bending vibration.

Holes 274 and 275 are formed at both the end portions in the longitudinal direction of the fixing section 273. Holes 284 and 285 are formed at both the end portions in the longitudinal direction of the fixing section 283.

Note that the projections 26 and the coupling sections 27 and 28 may be respectively provided as separate bodies from the main body section 20.

The number of coupling sections is not limited to the number described in this embodiment and may be, for example, one, two, three, or five or more. In this embodiment, the coupling sections are provided on both the sides of the main body section 20. However, not only this, but the coupling sections may be provided, for example, only on one end side of the main body section 20.

### Insulating Plates 75 and 76

The insulating plates 75 and 76 are respectively formed in rectangular shapes. The insulating plate 75 is disposed between a contact surface 311 of a first member 31 (explained below) of the holding section 3 and the fixing section 273 of the vibrating body 2. Similarly, the insulating plate 76 is disposed between a contact surface 312 of the first member 31 (explained below) of the holding section 3 and the fixing section 283 of the vibrating body 2. In this way, the first member 31 and the vibrating plate 23 are insulated from each other.

Consequently, even when a voltage is applied to the vibrating plate 23 to drive the piezoelectric actuator 1, it is possible to set the potential of the first member 31 to the earth potential.

Holes 751 and 752 are formed at both the end portions in the longitudinal direction of the insulating plate 75. Similarly, holes 761 and 762 are formed at both the end portions in the longitudinal direction of the insulating plate 76.

The constituent materials of the insulating plates and 76 are not respectively limited as long as the constituent materials are insulative materials. For example, various resin materials and various ceramic materials can be used.

Note that the insulating plates 75 and 76 may be omitted.

Instead of the insulating plates 75 and 76 or together with the insulating plates 75 and 76, an insulating plate may be disposed between a contact surface 321 of a second member 32 (explained below) of the holding section 3 and the fixing section 273 of the vibrating body 2. Similarly, an insulating plate may be disposed between a contact surface 322 of the second member 32 of the holding section 3. In this way, the second member 32 and the vibrating plate 23 may be insulated from each other. Consequently, even when a voltage is applied to the vibrating plate 23 to drive the piezoelectric actuator 1, it is possible to set the potential of the second member 32 to the earth potential.

### Holding Section 3

The holding section 3 is configured not to hinder the vibration of the vibrating body 2 and holds the vibrating body 2 to be capable of vibrating. The holding section 3 includes the first member 31 and the second member 32 to which the vibrating body 2 (the vibrating plate 23) is fixed. The fixing sections 273 and 283 are sandwiched by the first member 31 and the second member 32. In this way, the fixing sections 273 and 283 are fixed to the first member 31.

The first member 31 is disposed on the upper side of the vibrating body 2 in FIG. 1, that is, on the upper side of the electrodes 21a, 21b, 21c, and 21d in FIG. 1. The first member 31 may be configured by one member or may be configured by a plurality of members. In this embodiment, the first member 31 is configured by one member. The shape of the first member 31 is not particularly limited. In this embodiment, when viewed from the thickness direction of the vibrating plate 23 (the Z-axis direction), the first member 31 is formed in a rectangular shape.

The first member 31 includes, on the vibrating body 2 side, the contact surface 311 opposed to the fixing section 273 of the vibrating plate 23 and the contact surface 312 opposed to the fixing section 283. The contact surfaces 311 and 312 are respectively planes. The contact surfaces 311 and 312 are respectively formed in rectangular shapes.

An opening 313 is formed in the center portion of the first member 31. The opening 313 is disposed in a position opposed to the vibrating body 2 (the piezoelectric elements 22 and 24). With the opening 313, it is possible to radiate generated heat. It is possible to attain a reduction in weight. It is possible to check whether a wire that electrically connects predetermined electrodes among the electrodes 21a, 21b, 21c, and 21d and the wires 7210 and 7220 are normal. Further, for example, when the wires are connected by solder or the like, it is possible to prevent the solder from interfering with the first member 31.

Holes 314, 315, 316, and 317 are formed at four corner portions of the first member 31. Female screws 318 and 319 are formed at both the end portions on the lower side of the first member 31 in FIG. 2.

The second member 32 is disposed on the lower side of the vibrating body 2 in FIG. 1, that is, on the lower side of the electrodes 25a, 25b, 25c, and 25d in FIG. 1. The second member 32 may be configured by one member or may be configured by a plurality of members. In this embodiment, the second member 32 is configured by one member. The shape of the second member 32 is not particularly limited. In this embodiment, when viewed from the thickness direction of the vibrating plate 23 (the Z-axis direction), the second member 32 is formed in a rectangular shape.

The second member 32 includes, on the vibrating body 2 side, the contact surface 321 opposed to the fixing section 273 of the vibrating plate 23 and the contact surface 322 opposed to the fixing section 283. The contact surfaces 321 and 322 are respectively planes. The contact surfaces 321 and 322 are respectively formed in rectangular shapes.

An opening 323 is formed in the center portion of the second member 32. The opening 323 is disposed in a position opposed to the vibrating body 2 (the piezoelectric elements 22 and 24). With the opening 323, it is possible to radiate generated heat. It is possible to attain a reduction in weight. It is possible to check whether a wire that electrically connects predetermined electrodes among the electrodes 25a, 25b, 25c, and 25d and the wires 7230 and 7240 are normal. Further, for example, when the wires are connected by solder or the like, it is possible to prevent the solder from interfering with the second member 32.

Female screws 324, 325, 326, and 327 are formed at the four corner portions of the second member 32.

A hole 328 is formed on the upper side of the opening 323 of the second member 32 in FIG. 2. The wires 7210 to 7240 are inserted through the hole 328 and drawn out to the outside of the holding section 3. Consequently, it is possible to attain a reduction in the size of the piezoelectric actuator 1.

Note that the hole 328 may be formed in the first member 31 instead of the second member 32 or may be formed in both of the first member 31 and the second member 32.

The vibrating body 2 is screwed (fixed) to the holding section 3 by four screws 115, 116, 117, and 118 in the fixing sections 273 and 283. Specifically, first, the contact surface 311 of the first member 31, the insulating plate 75, the fixing section 273 of the vibrating body 2, and the contact surface 321 of the second member 32 are disposed in this order. Similarly, the contact surface 312 of the first member 31, the insulating plate 76, the fixing section 283 of the vibrating body 2, and the contact surface 322 of the second member 32 are disposed in this order. In a state in which the fixing sections 273 and 283 of the vibrating body 2 are sandwiched by the contact surfaces 311 and 312 of the first member 31 and the contact surfaces 321 and 322 of the second member 32 via the insulating plates 75 and 76, the screw 115 is inserted through the holes 314, 751, 274 in this order and screwed in the female screw 324, the screw 117 is inserted through the holes 316, 752, and 275 in this order and screwed in the female screw 326, the screw 116 is inserted through the holes 315, 761, and 284 in this order and screwed in the female screw 325, and a screw 118 is inserted through the holes 317, 762, and 285 in this order and screwed in the female screw 327.

In this way, the fixing sections 273 and 283 are sandwiched by the first member 31 and the second member 32. Therefore, when the fixing sections 273 and 283 are screwed (fixed) to the first member 31 and the second member 32, it is possible to suppress the coupling sections 271, 272, 281, and 282 from being bent or twisted by the screws to cause distortion in the coupling sections 271, 272, 281, and 282. Consequently, vibration is stabilized and a sufficient vibration characteristic is obtained. Further, since it is unnecessary to increase the thickness of the coupling sections 271, 272, 281, and 282, it is possible to improve vibration efficiency.

When each of the fixing sections 273 and 283 are configured by one member and is coupled to the main body section 20 by the two coupling sections 271 and 272 or the two coupling sections 281 and 282, it is likely that spurious vibration occurs. However, since the fixing sections 273 and 283 are sandwiched by the first member 31 and the second member 32, it is possible to suppress the spurious vibration and stabilize vibration.

Each of the first member 31 and the second member 32 is configured by one member. Therefore, in each of the first member 31 and the second member 32, it is possible to easily improve dimension accuracy in the positions of the fixing sections 273 and 283 and positions in the vicinities of the fixing sections 273 and 283. It is possible to increase the rigidity of the first member 31 and the second member 32.

Each of the dimensions of the first member 31 and the second member 32 is not particularly limited and is set as appropriate according to conditions. However, as shown in FIG. 5, in the thickness direction of the vibrating plate 23 (the Z-axis direction), when the thickness of the first member 31 is represented as L1, the thickness of the second member 32 is represented as L2, and the thickness of the fixing sections 273 and 274 is represented as L3, each of the L1 and L2 is preferably larger than L3. Consequently, it is possible to more surely sandwich the fixing sections 273 and 283 with the first member 31 and the second member 32 and further stabilize vibration.

When the thickness of the vibrating plate 23 is 0.1 mm, L1 is preferably 0.15 mm or more and 3 mm or less and more preferably 0.5 mm or more and 2 mm or less. L2 is preferably 0.15 mm or more and 3 mm or less and more preferably 0.5 mm or more and 2 mm or less.

If L1 and L2 are smaller than the lower limit values, it is likely that, depending on other conditions, the effect of stabilizing vibration decreases. If L1 and L2 are larger than the upper limit values, the piezoelectric actuator 1 is increased in size.

When the thickness of the vibrating plate 23 is 0.1 mm, L3 is preferably 0.02 mm or more and 2 mm or less and more preferably 0.1 mm or more and 0.5 mm or less.

If L3 is smaller than the lower limit value, it is likely that, depending on conditions such as a voltage applied to the vibrating plate 23 and material resistance, the insulation effect cannot be secured and a stable voltage cannot be applied. Therefore, it is likely that the effect of stabilizing the vibration of the vibrating plate 23 decreases. If L3 is larger than the upper limit value, the piezoelectric actuator 1 is increased in size.

The constituent materials of the first member 31 and the second member 32 are respectively not particularly limited. For example, various metal materials, various resin materials, and various ceramic materials can be used.

If the first member 31 has an insulation property, when a voltage is applied to the vibrating plate 23 to drive the piezoelectric actuator 1, even if the insulating plates 75 and 76 are omitted, it is possible to set the potential of the first member 31 to the earth potential. Similarly, if the second member 32 has an insulation property, it is possible to set the potential of the second member 32 to the earth potential. If the first member 31 and the second member 32 have insulation properties, it is possible to set the first member 31 and the second member 32 to the earth potential. Therefore, it is preferable that at least one of the first member 31 and the second member 32 has an insulation property.

### Base 4 and Leaf Springs 71 and 72

The base 4 supports the holding section 3, which holds the vibrating body 2, via the pair of leaf springs 71 and 72. The base 4 is fixed to the not-shown supporting body. The shape of the base 4 is not particularly limited. In this embodiment, the base 4 is formed in a longitudinal shape long in the X-axis direction.

Female screws 41 and 42 are formed at both the end portions in the longitudinal direction (the X-axis direction) of the base 4.

Each of the pair of leaf springs 71 and 72 is formed in a longitudinal shape. The leaf springs 71 and 72 are disposed in parallel to be separated from each other in the X-axis direction. The leaf springs 71 and 72 couple the holding section 3 and the base 4 in a state in which the leaf springs 71 and 72 sandwich the entire holding section 3.

In this case, holes 711 and 712 are formed at both the end portions in the longitudinal direction (the Y-axis direction) of the leaf spring 71. A hole 713 longer than the holes 711 and 712 is formed between the hole 711 and the hole 712 of the leaf spring 71. Similarly, holes 721 and 722 are formed at both the end portions in the longitudinal direction (the Y-axis direction) of the leaf spring 72. A hole 723 longer than the holes 721 and 722 is formed between the hole 721 and the hole 722 of the leaf spring 72. Note that, when viewed from the X-axis direction, the holes 713 and 723 are respectively larger than parts excluding the coupling sections 27 and 28 in the vibrating body 2.

A screw 112 is inserted into the hole 712 of the leaf spring 71 and screwed in the female screw 41 of the base 4. A screw 111 is inserted into the hole 711 of the leaf spring 71 and screwed in the female screw 318 of the first member 31. Consequently, one end portion (on the upper side in FIG. 2) of the leaf spring 71 is fixed to one end portion (on the left side in FIG. 2) of the base 4. The other end portion (on the lower side in FIG. 2) of the leaf spring 71 is fixed to one end portion (on the left side in FIG. 2) of the holding section 3. Similarly, a screw 114 is inserted into the hole 722 of the leaf spring 72 and screwed in the female screw 42 of the base 4. A screw 113 is inserted into the hole 721 of the leaf spring 72 and screwed in the female screw 319 of the first member 31. Consequently, one end portion (on the upper side in FIG. 2) of the leaf spring 72 is fixed to the other end portion (on the right side in FIG. 2) of the base 4. The other end portion (on the lower side in FIG. 2) of the leaf spring 72 is fixed to the other end portion (on the right side in FIG. 2) of the holding section 3.

Each of the leaf springs 71 and 72 is elastically deformed and urges the holding section 3, which holds the vibrating body 2, toward the rotor 5. That is, each of the leaf springs 71 and 72 urges the projection 26 of the vibrating body 2 toward the rotor 5 via the holding section 3. Consequently, it is possible to efficiently perform power transmission to the rotor 5 by the vibrating body 2.

The projection 26 of the vibrating body 2 projects from the hole 713. Consequently, it is possible to attain a reduction in the size of the piezoelectric actuator 1. When the piezoelectric actuator 1 is driven and the projection 26 performs an elliptical motion, it is possible to prevent, with the hole 713, the projection 26 and the leaf spring 71 from interfering with each other.

### Rotor 5

The rotor 5 is disposed forward in the X-axis direction of the vibrating section 10 having the configuration explained above.

The rotor 5 is held to be rotatable in a forward direction (clockwise) and a backward direction (counterclockwise), which is the opposite direction of the forward direction, around a bar-like shaft section 51 erected in the not-shown supporting body.

The projection 26 repeatedly comes into contact with an outer circumferential surface 52 of the rotor 5 according to the vibration of the vibrating body 2.

The basic configuration of the piezoelectric actuator 1 is explained above.

### Driving

The operation of the piezoelectric actuator 1 is explained.

The piezoelectric actuator 1 applies a positive voltage to the vibrating body 2 at a fixed cycle to vibrate the vibrating body 2 such that the projection 26 draws an elliptical track. The piezoelectric actuator 1 rotates the rotor 5 according to the vibration. A reason why the projection 26 draws the elliptical track is explained below with reference to FIGS. 6A to 10.

### Movement of the Projection 26

As explained above, the piezoelectric elements 22 and 24 repeat the application of the positive voltage and the release of the application of the positive voltage (apply positive charges at a fixed cycle) to repeat an operation for expanding in the longitudinal direction thereof and an operation for returning to the original shapes (an operation for contracting from an expanded state). Therefore, when the electrodes 21a, 21b, 21c, 21d, 25a, 25b, 25c, and 25d are energized at a fixed cycle and the positive voltage is applied at a fixed cycle between the electrodes 21a, 21b, 21c, 21d, 25a, 25b, 25c, and 25d and the vibrating plate 23, the piezoelectric elements 22 and 24 repeat contraction and expansion.

According to the expansion and contraction, the entire vibrating body 2 performs stretching vibration (longitudinal vibration) shown in FIGS. 6A and 6B in the XY plane.

When a frequency for applying a voltage is changed, a stretching amount suddenly increases at a certain specific frequency and a kind of a resonance phenomenon occurs. A frequency (a resonance frequency) at which resonance is caused by the stretching vibration is determined according to conditions such as a physical property of the vibrating body 2 and dimensions (width W, length L, and thickness T) of the vibrating body 2.

When the electrodes 21a, 21c, 25a, and 25c are energized at a fixed cycle and the positive voltage is applied at a fixed cycle between the electrodes 21a, 21c, 25a, and 25c and the vibrating plate 23, portions of the piezoelectric element 22 corresponding to the electrodes 21a and 21c and portions of the piezoelectric element 24 corresponding to the electrodes 25a and 25c repeat contraction and expansion.

On the other hand, the electrodes 21b, 21d, 25b, and 25d are not energized. Therefore, portions of the piezoelectric element 22 corresponding to the electrodes 21b and 21d and portions of the piezoelectric element 24 corresponding to the electrodes 25b and 25d do not contract and expand.

According to such expansion and contraction, the entire vibrating body 2 performs bending vibration shown in FIGS. 7A and 7B in the XY plane.

When the electrodes 21b, 21d, 25b, and 25d are energized at a fixed cycle and the positive voltage is applied at a fixed cycle between the electrodes 21b, 21d, 25b, and 25d and the vibrating plate 23, portions of the piezoelectric element 22 corresponding to the electrodes 21b and 21d and portions of the piezoelectric element 24 corresponding to the electrodes 25b and 25d repeat contraction and expansion.

On the other hand, the electrodes 21a, 21c, 25a, and 25c are not energized. Therefore, portions of the piezoelectric element 22 corresponding to the electrodes 21a and 21c and portions of the piezoelectric element 24 corresponding to the electrodes 25a and 25c do not contract and expand.

According to such expansion and contraction, the entire vibrating body 2 performs bending vibration shown in FIGS. 8A and 8B in the XY plane.

Note that, concerning the bending vibrations shown in FIGS. 7A and 7B and FIGS. 8A and 8B, there is also a resonance frequency determined by the conditions such as the physical property of the vibrating body 2 and the dimensions (the width W, the length L, and the thickness T) of the vibrating body 2.

As explained above, both of the resonance frequency of the stretching vibration shown in FIGS. 6A and 6B and the resonance frequency of the bending vibration shown in FIGS. 7A and 7B or FIGS. 8A and 8B are determined by the physical property of the vibrating body 2, the dimensions (the width W, the length L, and the thickness T) of the vibrating body 2, and the like. Therefore, if the dimensions (the width W, the length L, and the thickness T) of the vibrating body 2 are appropriately selected, the resonance frequencies can be set the same or can be set close to each other. When a voltage of a form of the bending vibration shown in FIGS. 7A and 7B or FIG. 8A or 8B is applied to the vibrating body 2 at the resonance frequency, the bending vibration shown in FIGS. 7A and 7B or FIGS. 8A and 8B occurs and, at the same time, the stretching vibration shown in FIGS. 6A and 6B is also induced.

As a result, when the voltage is applied in the form shown in FIGS. 7A and 7B, as shown in FIG. 9, the vibrating body 2 vibrates such that the projection 26 draws an elliptical track (a first elliptical track) indicated by an arrow DL1 (clockwise on the figure). Such vibration is referred to as first vibration mode.

On the other hand, when voltage is applied in the form shown in FIGS. 8A and 8B, as shown in FIG. 10, the vibrating body 2 vibrates such that the projection 26 draws an elliptical track (a second elliptical track) indicated by an arrow DR1 (counterclockwise on the figure). Such vibration is referred to as second vibration mode.

Note that, in the above explanation, the positive voltage is applied to the vibrating body 2. However, the piezoelectric elements 22 and 24 are also deformed by applying a negative voltage to the vibrating body 2. Therefore, the bending vibration (and the stretching vibration) may be caused by applying the negative voltage to the vibrating body 2 or may be caused by applying an alternating voltage, which repeats the positive voltage and the negative voltage, to the vibrating body 2.

In the above explanation, the voltage having the resonance frequency is applied. However, it is sufficient to apply a voltage having a waveform including the resonance frequency. The applied voltage is not limited to the voltage having the waveform and may be, for example, a pulse-like voltage.

### Motion of the Rotor 5

The vibrating body 2 rotates the rotor 5 using the first vibration mode or the second vibration mode.

Specifically, as shown in FIG. 9, when the vibrating body 2 is vibrated in the first vibration mode, the vibrating body 2 vibrates such that the projection 26 draws the elliptical track indicated by the arrow DL1. Therefore, the rotor 5 rotates counterclockwise as indicated by an arrow SR in FIG. 9 with a frictional force received from the projection 26.

On the other hand, as shown in FIG. 10, when the vibrating body 2 is vibrated in the second vibration mode, the vibrating body 2 vibrates such that the projection 26 draws the elliptical track indicated by the arrow DR1. Therefore, the rotor 5 rotates clockwise as indicated by an arrow SL in FIG. 10 with a frictional force received from the projection 26.

In this way, the rotor 5 rotates clockwise or counterclockwise according to the vibration of the vibrating body 2.

As explained above, in the piezoelectric actuator 1, the fixing sections 273 and 283 are sandwiched by the first member 31 and the second member 32. Therefore, when the fixing sections 273 and 283 are screwed (fixed) to the first member 31 and the second member 32, it is possible to suppress the coupling sections 271, 272, 281, and 282 from being bent or twisted by the screws to cause distortion in the coupling sections 271, 272, 281, and 282. Consequently, vibration is stabilized and a sufficient vibration characteristic is obtained. Since it is unnecessary to increase the thickness of the coupling sections 271, 272, 281, and 282, it is possible to improve vibration efficiency. Further, it is possible to suppress spurious vibration and stabilize vibration.

### Second Embodiment

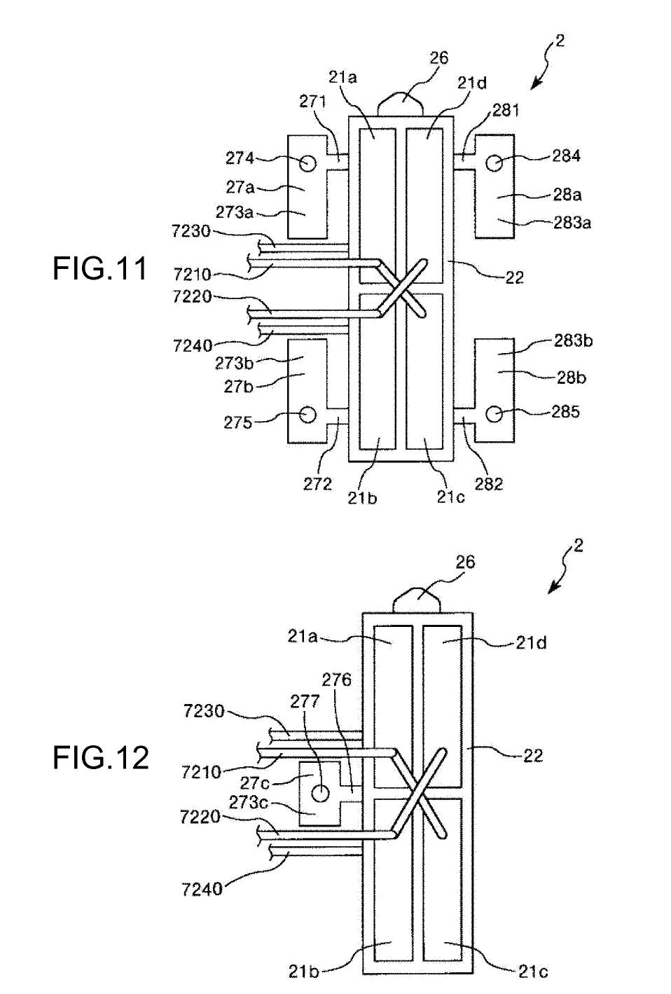

FIG. 11 is a plan view showing a vibrating body of a piezoelectric actuator according to a second embodiment of the invention.

The second embodiment is explained below centering on differences from the first embodiment. Explanation of similarities is omitted.

As shown in FIG. 11, in the piezoelectric actuator 1 in the second embodiment, in the vibrating plate 23 of the vibrating body 2, a pair of coupling sections 27a and 27b disposed to be separated from each other is provided instead of the coupling section 27. A pair of coupling sections 28a and 28b disposed to be separated from each other is provided instead of the coupling section 28. The coupling section 27a includes a fixing section 273a and the coupling section 271 that couples the main body section 20 and the fixing section 273a. The coupling section 27b includes a fixing section 273b and the coupling section 272 that couples the main body section 20 and the fixing section 273b. The coupling section 28a includes a fixing section 283a and the coupling section 281 that couples the main body section 20 and the fixing section 283a. The coupling section 28b includes a fixing section 283b and the coupling section 282 that couples the main body section 20 and the fixing section 283b.

With the piezoelectric actuator 1, effects same as the effects in the first embodiment are obtained.

### Third Embodiment

FIG. 12 is a plan view showing a vibrating body of a piezoelectric actuator according to a third embodiment of the invention.

The third embodiment is explained below centering on differences from the first embodiment. Explanation of similarities is omitted.

As shown in FIG. 12, in the piezoelectric actuator 1 in the third embodiment, in the vibrating plate 23 of the vibrating body 2, a coupling section 27c is provided only at one end portion in the width direction of the main body section 20 instead of the coupling sections 27 and 28. The coupling section 27c includes a fixing section 273c and a coupling section 276 that couples the main body section 20 and the fixing section 273c. The coupling section 276 is disposed in the center portion in the longitudinal direction of the main body section 20. A hole 277, into which a screw is inserted, is formed in the fixing section 273c.

With the piezoelectric actuator 1, effects same as the effects in the first embodiment are obtained.

The piezoelectric actuators in the embodiments are explained above. However, the invention is not limited to the embodiments. The components can be replaced with any components having the same functions. Any other components may be added to the invention.

The invention may be a combination of any two or more configurations (features) in the embodiments.

In the embodiments, the driven body is the component of the piezoelectric actuator. However, in the invention, the driven body is not limited to the component of the piezoelectric actuator. The driven body does not have to be included in the components of the piezoelectric actuator.

In the embodiment, as the driven body, the rotatably set rotor is explained as the example. However, the driven body is not limited to the rotor. Besides, examples of the driven body include a driven body set to be movable in a predetermined direction. The shape of the rotatable driven body is not limited to the circular shape and may be, for example, a polygonal shape such as an icosagonal shape. Examples of the shape of the movable driven body include a linear shape and a curved bar shape. The driven body may be a rigid body or may have flexibility.

Uses of the piezoelectric actuators in the embodiments are not particularly limited. The piezoelectric actuators can be used for driving of predetermined parts of various devices such as driving of joints of various robots and driving of various end effectors such as hands of the robots.

The entire disclosure of Japanese Patent Application No. 2014-110945, filed May 29, 2014 is expressly incorporated by reference herein.

What is claimed is:

1. A piezoelectric actuator comprising:
a piezoelectric element;
a vibrating plate including a main body section provided with the piezoelectric element, a fixing section, and a coupling section that couples the main body section and the fixing section; and
a first member to which the vibrating plate is fixed, wherein
the fixing section is fixed to the first member by sandwiching the fixing section with the first member and a second member.

2. The piezoelectric actuator according to claim 1, wherein, in a thickness direction of the vibrating plate, each of thicknesses of the first member and the second member is larger than thickness of the fixing section.

3. The piezoelectric actuator according to claim 1, wherein
when viewed from a thickness direction of the vibrating plate, the main body section has a pair of sides opposed to each other, and
the vibrating plate includes a plurality of the coupling sections on one of the pair of sides of the main body section.

4. The piezoelectric actuator according claim 3, wherein the fixing section is configured by one member and is coupled to the main body section by the plurality of coupling sections.

5. The piezoelectric actuator according claim 1, wherein
when viewed from a thickness direction of the vibrating plate, the main body section has a pair of sides opposed to each other, and
the vibrating plate includes a plurality of the coupling sections on each of the pair of sides of the main body section.

6. The piezoelectric actuator according to claim 5, wherein
the piezoelectric actuator includes a pair of the fixing sections,
each of the pair of fixing sections is configured by one member,
one of the pair of fixing sections is coupled to the main body section by the plurality of coupling sections provided on one of the pair of sides of the main body section, and
the other of the pair of fixing sections is coupled to the main body section by the plurality of coupling sections provided on the other of the pair of sides of the main body section.

7. The piezoelectric actuator according to claim 1, wherein the piezoelectric actuator includes an insulating member at least between the first member and the fixing section or between the second member and the fixing section.

8. The piezoelectric actuator according to claim 1, wherein at least one of the first member and the second member has an insulation property.

9. The piezoelectric actuator according to claim 1, wherein a hole, through which a wire electrically connected to the piezoelectric element is inserted, is provided in at least one of the first member and the second member.

10. The piezoelectric actuator according to claim 1, wherein an opening is provided in a position opposed to the piezoelectric element of at least one of the first member and the second member.

11. The piezoelectric actuator according to claim 1, wherein each of the first member and the second member is configured by one member.

12. The piezoelectric actuator according to claim 1, further comprising a driven body provided to be displaceable, wherein
the vibrating plate includes a contact section that comes into contact with the driven body.

13. A robot comprising the piezoelectric actuator according to claim 1.

14. A robot comprising the piezoelectric actuator according to claim 2.

15. A robot comprising the piezoelectric actuator according to claim 3.

16. A robot comprising the piezoelectric actuator according to claim 4.

17. A robot comprising the piezoelectric actuator according to claim 5.

18. A robot comprising the piezoelectric actuator according to claim 6.

19. A robot comprising the piezoelectric actuator according to claim 7.

20. A robot comprising the piezoelectric actuator according to claim 8.
